(19) United States
(12) Patent Application Publication
(10) Pub. No.: US 2004/0077332 A1
(43) Pub. Date: Apr. 22, 2004

(54) Management of pre-paid billing system for wireless communication

(76) Inventors: Dafna Ephraim, Hod Hasharon (IL); Michael Kertesz, Tel Aviv (IL); Bruce Frankel, Marlton, NJ (US); Gadi Inon, Rosh Ha'ain (IL)

Correspondence Address: SUGHRUE MION, PLLC, 2100 PENNSYLVANIA AVENUE, N.W., SUITE 800, WASHINGTON, DC, 20037, US

(21) Appl. No.: 10/467,664

(22) PCT Filed: Feb. 8, 2002
(86) PCT No.: PCT/US02/01243

(51) Int. Cl. H04K 1/00; H04L 9/00; G06F 17/60; H04M 11/00

(52) U.S. Cl. 455/405; 455/406; 705/64

(57) ABSTRACT

A system (FIG. 1) and method for providing prepaid data transfer services to a subscriber (12) through a communication device, such as a wireless or wireline device. The communication device is connected to a data network for transferring data from a data source, such as the Internet (24). A prepaid system monitors the data network in order to determine whether a particular requested data transfer should be authorized or continued, for example according to the prepaid amount available in the account of the system.

### FIELD AND BACKGROUND OF THE INVENTION

The present invention is of a method and a system for management of prepaid billing for communication systems, and in particular, of such a system and method for real time pre-paid billing for data transfer in the wireless and wireline communication environment. The present application claims priority under 35 U.S.C. § 119 based on U.S. Provisional Application 60/267,413 filed on Feb. 9, 2001.

Cellular telephones are becoming increasingly popular for portable telephone use, particularly for users who are interested in rapid, mobile data communication. As the amount of computational power and memory space which are available in such small, portable electronic devices increases, demand arises for different types of communication services through such devices. In particular, users have demanded that cellular telephones receive many different types of multimedia data, including e-mail (electronic mail) messages and Web pages.

In response to such demands, and to extend the power and efficacy of operation of portable, wireless electronic communication devices, the WAP (wireless application protocol) standard has been developed. Another such data transfer standard is known as “i-Mode”, which is currently used in Japan for data transfers, but which is also now being considered for operation in Europe and other countries. These data transfer standards enable the subscriber to access the Internet through the wireless communication device. In addition, various messaging standards such as SMS (short messaging service) also exist, and can be used to transfer text based messages between wireless communication devices.

All of these different types of wireless data services are currently provided to data-enabled wireless telephones by servers or gateways. Typically, these servers or gateways are connected to a wireless telephone network on one side and to some other network (“external network”), such as the Internet, on the other side. For example, an SMSC receives a text message from the Internet or other source and sends one or more data packets over a wireless telephone network to a particular wireless telephone, which then displays the text message on the wireless telephone's display screen. In another example, an HDML or WAP gateway receives a request generated by a micro-browser in the wireless telephone and sends a corresponding request to a server on the Internet. The Internet server responds with data, typically formatted according to a markup language, such as HDML or WML, and the gateway forwards this data to the micro-browser for display on the wireless telephone's screen. Alternatively, the gateway reformats the data according to a different standard data format before sending the data to the wireless telephone.

Regardless of the particular data transfer standard which is used, a basic requirement for effectively operating such services is the ability to appropriately bill the subscriber for these types of services. The current specifications and implementations of wireless data network elements do not allow for real-time data billing. The actual need may vary, depending on the types of services being offered and the role of the operator in offering such services, but the need for a real-time prepaid data billing solution is evident.

One example of a system in which such a pre-paid data service billing solution would be useful is the GPRS (general packet radio service) system, as shown in background art FIG. 1. The GPRS architecture features a system 10 which contains a wireless device 12, which may be a cellular telephone for example. Wireless device 12 is connected to a base station 14, which contains a BSC (base station controller) 16. BSC 16 is in turn in communication with a SGSN (serving GPRS support node) 18. SGSN 18 is a network element which is responsible for supporting data communication between wireless device 12 (through BSC 16) and an internal GPRS packet network 20, including packet routing and transfer, mobility management, logical link management, and authentication and charging functions

Internal GPRS packet network 20 is in turn in communication with a GGSN (gateway GPRS support node) 22, which for the purposes of this explanation is an example of one implementation of a data gateway, connecting an internal data network (internal GPRS packet network 20) to an external network, such as the Internet 24. GGSN 22 connects GPRS packet network 20 to the Internet 24. GGSN 22 communicates with devices connected to the Internet 24 (not shown) through such protocols as Radius, and effectively acts as an IP routing platform. GGSN 22 also converts the GPRS packets received from SGSN 18 into the appropriate packet data protocol format, such as IP or X.25 for example, as well as re-addressing packets received from Internet 24 into the correct address of wireless device 12, typically the correct GSM address.

Although background art system 10 operates effectively for the purpose for which it was designed, namely the transfer of data between the Internet 24 and wireless device 12, background art system 10 unfortunately has a number of drawbacks with regard to billing. As previously described, the network elements of background art system 10, such as GGSN 22 and SGSN 18, currently cannot support billing activities.

There is, therefore, a need for a system for billing for wireless data communications that both enables individuals without sufficient credit to engage in this type of communication and ensures all data communications are paid for, without extending credit to these individuals.

### SUMMARY OF THE INVENTION

The present invention is a system and method for providing prepaid data transfer services to a subscriber through a wireless device. The wireless device is connected to a data network for transferring data from a data source, such as the Internet, for example. A prepaid system monitors the data network in order to determine whether a particular requested data transfer service should be authorized, for example according to the amount available in the account of the subscriber. It should be noted that the description of the present invention is discussed in terms of a wireless communication system, however, the present invention can be equally applied to wireline communication systems with existing, known wireline technologies, without altering the scope of the present invention.

In one embodiment of the invention, the flow of operations is described as follows. First; the subscriber prepays for service, which can be accomplished according to any one of a number of different mechanisms which are known in the background art. Next, the subscriber uses a wireless device, such as a cellular telephone for example, to access data services, such as SMS or the Internet. The request for access is intercepted by the prepaid billing system of the present invention, which is preferably connected between the external network and a GGSN, or other gateway, which resides between the external network (such as the Internet) and the internal data network (such as an internal GPRS packet network). The prepaid system thereby intercepts data traffic which would otherwise travel directly between the external network and the internal data network, as well as between the wireless device and the external network.

The prepaid system preferably then determines how the data traffic should be handled. For example, the prepaid system could optionally selectively allow the data traffic to flow, or alternatively could discard the traffic, depending on the remaining account balance of the subscriber and, optionally, the nature of the traffic. The prepaid system preferably examines packets representing requests or data flowing from, or to, the wireless device and debits the prepaid account balance for the subscriber. According to preferred embodiments of the present invention, the calculation of the debit is divided into two parts. According to a first part, the component of the prepaid system which actually receives the request from the user calculates the debit in terms of “tokens”, which are arbitrary internal units for charging for data transfer. Next, in the second part of the calculation process, the value of the tokens is converted to a monetary value for debiting the account of the user, optionally according to particular characteristics of the user. Thus, the component of the prepaid system according to the present invention which receives the request, such as the data monitor, may optionally not receive any information about the user, but only sufficient tokens for the data transfer process to occur. Preferably, however, the class of service information is received.

The amount of the debit can depend on the size of the packet or the number of packets, for example the account can be debited for each “n” bytes or for each page to be displayed. Optionally, the amount of the debit could depend on the type of request or data in the packet. For example, request packets might optionally be free. Music data might optionally be charged at a lower rate than other kinds of data packets. Packets with error messages might be free. The amount debited might depend on the URL of the destination of the request or the source of the data being returned. Some URLs could optionally and preferably be “sponsored”, in that the owner of the server that handles that URL pays part or all of the cost of requests and/or data sent to/from the server.

Optionally, the amount of debit depends upon the date and time of the data transfer, and the location of the mobile device at the time of transfer, as well as the subscriber's class of service (CoS).

The prepaid system preferably allows packets to be transferred between the wireless device and the data service provider (server) only if the subscriber's account balance is sufficient and/or if the packets are “free”. Optionally and more preferably, the system notifies the subscriber when the subscriber's balance is low or exhausted, for example via an SMS message or an HDML message sent to the wireless device. Alternatively, the prepaid system can optionally notify the subscriber by sending a message containing a pointer (for example a “recharge URL”) to a page that contains such a message.

Hereinafter, the term “wireless device” refers to any type of electronic device which permits data transmission and/or reception through a wireless channel, for example through transmission and/or reception of radio waves. Hereinafter, the term “cellular telephone” is a wireless device designed for the transmission of voice data and/or other data. Non-limiting examples of such data include text data, graphical data, audio data, video data, and “documents” described in a “mark-up” language.

Hereinafter, the term “computational device” includes, but is not limited to, any type of wireless device and any type of computer. Examples of wireless devices include, but are not limited to, handheld devices, including devices operating with the Palm OS®; hand-held computers, PDA (personal data assistant) devices, cellular telephones, any type of WAP (wireless application protocol) enabled device, and wearable computers of any sort, which can be connected to a network as previously defined and which have an operating system.

The present invention could be implemented in software, firmware or hardware. The present invention could be implemented as substantially any type of integrated circuit or other electronic device capable of performing the functions described herein.

In any case, the present invention can be described as a plurality of instructions being executed by a data processor, in which the data processor is understood to be implemented according to whether the present invention is implemented as software, hardware or firmware.

### BRIEF DESCRIPTION OF THE DRAWINGS

The invention is herein described, by way of example only, with reference to the accompanying drawings, wherein:

FIG. 1 is a schematic block diagram showing a background system;

FIG. 2 is a schematic block diagram showing a system according to the present invention for pre-paid billing of data services;

FIG. 3 is a schematic block diagram of a system for voice and data integration according to the present invention;

FIG. 4 is a schematic block diagram of an exemplary system for voice and data transfer according to the present invention;

FIG. 5 is a schematic block diagram of an alternate exemplary system for voice and data transfer according to the present invention;

FIG. 6 is a schematic block diagram of an additional alternate exemplary system for voice and data transfer according to the present invention; and

FIG. 7 is a schematic block diagram of another alternate exemplary system for voice and data transfer according to the present invention.

### DESCRIPTION OF THE PREFERRED EMBODIMENTS

The present invention will be explained in further detail by making reference to the accompanying drawings, which do not limit the scope of the invention in any way. Again, it should be noted that the application of the present invention is not limited to wireless communication systems, but can also be applied in wireline communication systems, using existing and known technologies in a similar fashion to that disclosed below.

The present invention is of a system and method for providing prepaid data transfer services to a subscriber through a wireless device. The wireless device is connected to a data network for transferring data from, or to, a data source, such as the Internet. A prepaid system monitors the data network in order to determine whether a particular requested data transfer service should be authorized, for example, according to the amount available in the account of the subscriber.

In one embodiment, the flow of operations is described as follows. First, the subscriber prepays for service, which can be accomplished according to any one of a number of different mechanisms which are known in the background art. Next, the subscriber uses a wireless device, such as a cellular telephone for example, to access data services, such as SMS or the Internet. The request for access is intercepted by the prepaid billing system of the present invention, which is preferably connected between the external network (for example the Internet 24) and GGSN 22, or other gateway which resides between the external network and the internal data network (such as an internal GPRS packet network 20). The prepaid system thereby intercepts data traffic which would otherwise travel directly between the external network and the internal data network, as well as between the wireless device and the external network.

The prepaid system preferably then determines how the data traffic should be handled. For example, the prepaid system could optionally selectively allow the data traffic to flow, or alternatively could discard the traffic, depending on the remaining account balance of the subscriber and, optionally, the nature of the traffic. The prepaid system preferably examines packets representing requests or data flowing from, or to, the wireless device and debits the prepaid account balance for the subscriber. According to preferred embodiments of the present invention, the calculation of the debit is divided into two parts. In the first part, the component of the prepaid system which actually receives the request from the user calculates the debit in terms of “tokens”, which are arbitrary internal units for charging for data transfer. It is noted that although the present discussion involves a server controlling the billing process, it is also contemplated that the wireless device can used and programmed to control or manage the prepaid billing as described herein.

Next, in the second part of the calculation process, the value of the “tokens” is converted to a monetary value for debiting the account of the user, optionally according to particular characteristics of the user. Thus, the component of the prepaid system according to the present invention which receives the request, such as the data monitor, may optionally not receive any information about the user, but only sufficient tokens for the data transfer process to occur. Preferably, however, the class of service information is received.

The way in which the debit is calculated can vary, and the amount of the debit can depend on the size of the packet or the number of packets. For example, the account can be debited for each “n” bytes or for each page to be displayed. Optionally, the amount of the debit can depend on the type of request or data in the packet. For example, request packets might optionally be free. Music data might optionally be charged at a lower rate than other kinds of data packets. Packets with error messages might be free. The amount debited might depend on the URL of the destination of the request or the source of the data being returned. Some URLs could optionally and preferably be “sponsored”, in that the owner of the server that handles that URL pays part or all of the cost of requests and/or data sent to/from the server.

Additionally, the amount of debit could depend upon the date and time of the data transfer, and/or the location of the mobile device at the time of transfer, as well as the subscriber's class of service (CoS).

The prepaid system preferably allows packets to be transferred between the wireless device and the data service provider (server) only if the subscriber's account balance is sufficient and/or if the packets are “free”. Optionally and more preferably, the system notifies the subscriber when the subscriber's balance is low or exhausted, for example via an SMS message or an HDML message sent to the wireless device. Alternatively, the prepaid system can optionally notify the subscriber by sending a message containing a pointer (for example a “recharge URL”) to a page that contains such a message.

The principles and operation of a method and a system according to the present invention may be better understood with reference to the drawings and the accompanying description. It is understood that although the present invention is described with regard to GPRS, this is for the purposes of description only and is without any intention of being limiting, as the present invention would also optionally be operative with other data networks, such as CDMA, WCDMA (3G), iDen and even Circuit Switched Data, and any other known or used data network. Since data monitoring is done between the internal Packet Data Network and the Internet (or another external network), the product can work with any such internal Packet Data Network.

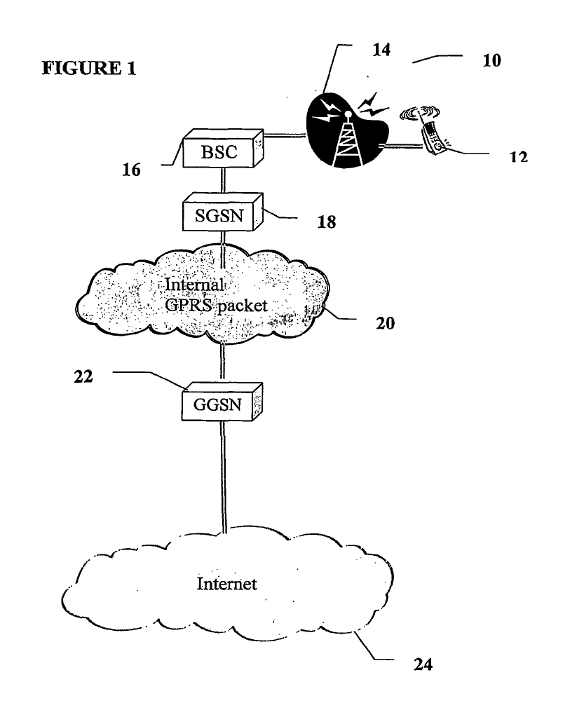

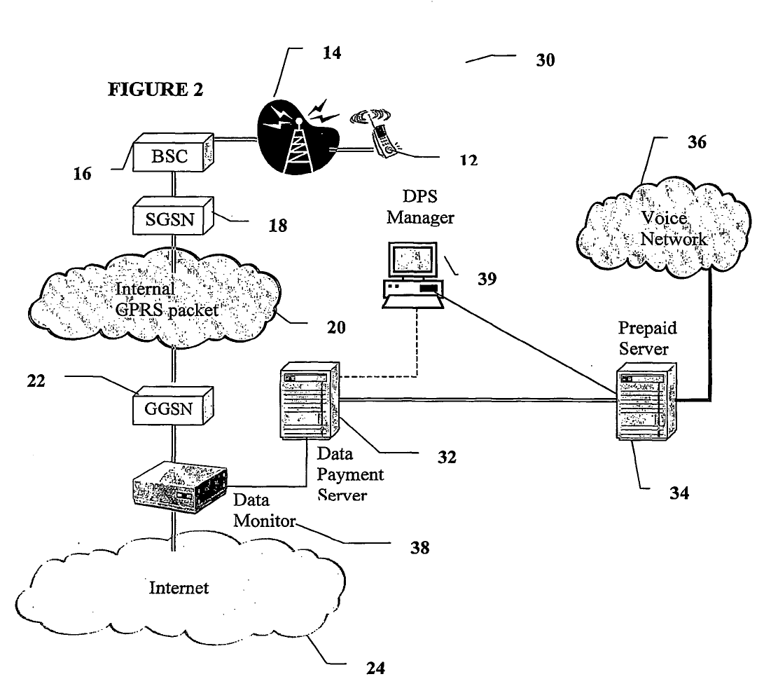

Referring now to the drawings, FIG. 2 shows an exemplary implementation of a system 30 according to the present invention. System 30 features a number of the same elements as system 10 of background art FIG. 1; unless otherwise noted, identically numbered elements have at least the functionality described with regard to FIG. 1.

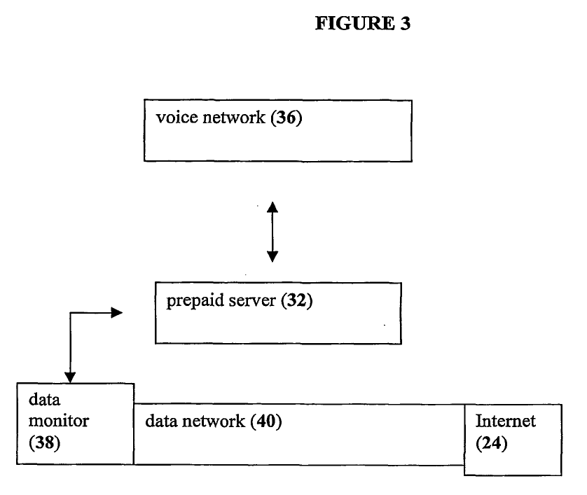

System 30 differs from background art system 10 in that system 30 also features a data payment server 32, a data monitor 38 and a prepaid server 34. As described in greater detail with regard to FIG. 3 below, optionally and preferably, prepaid server 34 is also in communication with a voice network 36. Data payment server 32, however, is more preferably only in communication with the data transfer elements of system 30. Data payment server 32 is an optional but preferred component of system 30 for management of the prepaid system and for handling protocols.

As shown, prepaid server 34 communicates with data monitor 38 (optionally through Data Payment Server 32) in order to be able to determine the type of data transfer services which are being provided from Internet 24 and/or another external network. Data monitor 38 monitors all data traffic from Internet 24 and/or another external network, and reports on a number of characteristics of such traffic to prepaid server 34. Such characteristics include, but are not limited to, the type of data being transferred and/or the type of data which is requested to be transferred, the amount of data being transferred and the identity of the subscriber (or wireless device 12) for which the data is being transferred. For example, request packets might optionally be free. Music data might optionally be charged at a lower rate than other kinds of data packets. Packets with error messages might be free. Thus, data monitor 38 more preferably calculates the charge for the data transfer according to an arbitrary internal unit, which is described in greater detail below as a “token”, which most preferably does not require any information about one or more characteristics of the subscriber.

Prepaid server 34, data payment server 32 and data monitor 38 may collectively be termed a “prepaid system”, and optionally may also include a DPS manager 39 (see below for a description).

Prepaid server 34 preferably receives the number of tokens, or other information, from data monitor 38 (optionally through Data Payment Server 32), and then calculates the amount of payment which is required for the data transfer to occur, more preferably according to at least some of the above characteristics. This amount of payment is preferably calculated in terms of actual money to be charged to the account of the subscriber and, therefore, preferably represents a conversion from the arbitrary tokens of data monitor 38.

Optionally, payment could also be calculated according to the date and time of day for the transfer. The amount debited might also optionally depend on the service provider for the data transfer service, such as according to the URL of the destination of the request or the source of the data being returned. Some URLs or other specific data sources could optionally and preferably be “sponsored”, in that the owner of the server that handles that URL pays part or all of the cost of requests and/or data sent to/from the server (not shown).

According to one embodiment of the present invention, the charging of subscribers can be based on, or controlled by, the amount of data being transferred (which can optionally and preferably include different basic billing blocks, such as bytes, kilobytes, images, songs, documents, programs and so forth). Additionally, different rates for uplink and downlink can be used. Also, for content-based billing, differential billing according to such data characteristics as the content type of the data (such as WAP or HTTP for example), data protocol (WAP, HTTP, FTP, TELNET, POP3, and so forth) and location of the data source (such as the URL for WAP and HTTP transfers), can be used, alone or in combination.

Other preferred features include the ability to determine rates according to the time of day, the date or other time-based rate information. Service is also optionally and more preferably determined according to access control rules for different classes of service, which are in turn determined according to one or more characteristics of the subscribers. Different subscribers might, therefore, be charged different amounts for the same data, according to their class of service. Additionally, special rules are also optionally and more preferably determined for secured protocol transfer.

Further, one optional but particularly preferred feature, of the present invention, is that data monitor 38 calculates the total amount required for the data transfer to occur before such a transfer actually occurs, at the stage when the subscriber is sending the request for the data transfer. If such a calculation is performed in terms of an arbitrary internal unit such as tokens, then preferably a sufficient number of such tokens or other units are received from prepaid server 34, which then debits the account of the subscriber accordingly. This procedure predicts the cost of the transmission and ensures that the subscriber's account can afford this predicted cost. Optionally and more preferably, data monitor 38, preferably in conjunction with prepaid server 34 (optionally through Data Payment Server 32), also calculates the actual amount required for the data transfer as it actually occurred, since the transfer may not be successful if the connection to the data source and/or to wireless device 12 is lost, for example, in which case less data is sent than predicted. In other cases, more data is sent than predicted.

In any case, data monitor 38 sends the required number of tokens to be obtained from the account of the subscriber to prepaid server 34 (optionally through Data Payment Server 32), if data monitor 38 does not have sufficient tokens for that particular subscriber. Prepaid server 34 then determines whether the account of the subscriber has sufficient funds to cover the requested number of tokens. If sufficient funds are available, then prepaid server 34 sends the required tokens to data monitor 38, thereby enabling the transfer to occur, and debits the account of the subscriber appropriately. Alternatively, if sufficient funds are not available, then prepaid server 34 sends a message to data monitor 38 to block the transfer, and does not send the tokens. Such a message is then optionally and more preferably also sent to the subscriber through wireless device 12.

Optionally and more preferably, the subscriber is notified of changes in balance and account status while wireless device 12 is engaged in a data transfer. Most preferably, the subscriber is notified that access denial is about to occur during the data transfer, if the remaining amount in the account of the subscriber is not sufficient to complete the data transfer. For example, if data monitor 38 requires tokens for the transfer, but is informed by prepaid server 34 (optionally through Data Payment Server 32) that no more tokens can be obtained, then preferably this imminent access denial is communicated to the subscriber. According to other preferred embodiments of the present invention, the subscriber is allowed to have a negative amount in the user account, similar to an overdraft at a bank, for example in order to permit a data transfer operation to be completed even after the prepaid subscriber account has been depleted of funds. Such a negative amount may optionally be limited according to a “threshold of denial”, below which the subscriber is denied further service until money is again transferred into the account.

Also optionally, Call Detail Records (CDRs) are created for data transfers for prepaid subscribers. CDRs are records generated and stored in the prepaid system. These records provide an audit of charges applied to a subscriber's account. In support of data transfers, these records minimally contain the subscriber ID, time, date, charge amount, and type (data transfer) for each charge applied.

According to an exemplary but preferred implementation of the present invention, each prepaid subscriber receives services according to a specific class of a number of different classes, which are defined by the operator. For each class of service there are one or more rules, or parameters.

The parameters for each class of service optionally and more preferably include, but are not limited to, the type of service according to various data sources (identified for example by the destination URL, IP Address or other means), such as news, banks and/or other financial institutions for management of financial account(s) of the subscriber, games and so forth; the type of protocol which is required to deliver the service such as HTTP, FTP, WAP and so forth; the direction of data transfer for uplink vs. downlink; the content type such as text, image, animation, video, audio and so forth; and access permission to any particular type of service, defined as permit or deny. The operator is then preferably responsible for defining the priority between the different rules of the same class of service.

One example of such a set of rules is shown in the table below. As shown, each rule pertains to a particular class of service (CoS), and may also be determined according to any one or more of the following characteristics of the data transfer: a particular service within the class (“service”), a particular protocol for the data (“protocol”), the direction of data transfer (“up/down”), the type of content (“content type”), the status (return code of the application level protocol, such as HTTP “status” return flag), whether access permission is permitted or denied, and the weight. The weight is the number of tokens that should be charged for every basic billing block of data that matches the specified transfer rules (such as Protocol, Content, Status and so forth). The weight is a real number, and is more preferably permitted to be a fraction, as well as positive, zero or negative.

| | | | | | | | Access | |
|---|---|---|---|---|---|---|---|---|
| # | CoS | Service | Protocol | Up/Down | Content Type | Status | Permission | Weight |
| 1 | 5 | News | * | * | * | * | + | 2 |
| 2 | 5 | * | * | * | * | * | + | 1 |
| 3 | 6 | Bank | * | UP | * | * | + | 0 |
| 4 | 6 | Bank | * | DOWN | * | * | + | 2.5 |
| 5 | 6 | * | * | * | * | * | Deny | 0 |
| 6 | 99 | * | HTTP | * | Text | * | + | 1 |
| 7 | 99 | * | HTTP | * | Image | * | + | 0.2 |
| 8 | 99 | * | FTP | * | * | * | + | 0.1 |
| 9 | 99 | * | * | * | * | * | + | 5 |
| 10 | 20 | * | WAP | * | * | Not | + | 0 |
| | | | | | | Found | | |

Data monitor 38 is preferably responsible for finding the exact rule which matches the data being monitored, and then to calculate a charge for the data transfer. More preferably, the charge is calculated according to a number of tokens to be paid for this data transfer. The calculation is optionally performed according the following equation:

#Tokens=Weight * Basic Billing Block

in which the basic billing block is a parameter which is configured by the operator, and the weight is the amount of such billing blocks which is required to pay for each such data transfer service. Each token is thus a basic unit for charging the subscriber. Prepaid server 34 determines how much money is available to the subscriber. Data monitor 38 calculates the number of tokens required for each transaction and then requests more tokens from prepaid server 34 as necessary (optionally through Data Payment Server 32). If sufficient tokens are available, then data monitor 38 enables the data transfer to occur.

Prepaid server 34 is, therefore, also responsible for translating the money received from the subscriber into tokens, optionally and more preferably according to the date, time, location of the mobile station at the time of transfer and subscriber's Class of Service. In order to assist communication between data monitor 38 and prepaid server 34 (optionally through Data Payment Server 32), a Token Request and Refund Message is more preferably provided. This message is preferably used by data monitor 38 to interact with prepaid server 34 for subscriber authentication and token transfers. This message is optionally divided into several parts. A first part is the “request tokens” part, which is used to request subscriber configuration information and debit a subscriber's account. A “refund tokens” part is preferably used to refund unused tokens. Both parts can optionally be combined in one message.

The message is optionally used in four different situations. First, when the subscriber is trying to connect to the data transfer service, the message is used to check whether the subscriber is a prepaid user and an initial “chunk” of tokens is sent to data monitor 38 for the subscriber's use. Next, if the subscriber's credit at data monitor 38 is zero, and more tokens are required to continue data transfer, the message is also preferably sent in order to receive more tokens. In addition, the message is used when the previously transmitted tokens have expired, in which case they are refunded and new (fresh) tokens are requested, or when the user disconnects. The expiration of tokens occurs at any interval, or at any set time, desired by the system operator. Expiration is used to value tokens differently for different times of use. For example, on weekends and holidays tokens can be valued at 40 tokens for $1.00, whereas nights can be valued at 30 tokens for $1.00 and daytime/weekday tokens can be valued at 20 tokens for $1.00. In the preferred embodiment, the prepaid server 34 sends the tokens to the data monitor 38 (optionally through Data Payment Server 32) with expiration times, so that the data monitor 38 send the tokens back to the prepaid server 34 when they expire to exchange them for “new” tokens reflecting the new value.

Optionally and most preferably, a DPS manager 39 is provided for managing the functions of data payment server 32, data monitor 38 and/or prepaid server 34.

FIG. 3 is a schematic block diagram of another preferred embodiment of the present invention, in which prepaid server 34 handles prepaid services for both a voice network 36 and a data network 40. Data network 40 is shown as being connected to both the Internet 24 and data monitor 38. In this preferred embodiment, prepaid server 34 distributes tokens to both data monitor 38 and voice network 36, such that both types of services can optionally be operated on a prepaid basis.

In yet another embodiment of the present invention, a slightly different billing system is used, particularly when a voice call is being handled by the voice network 36. In this embodiment, in addition to the prepaid server 34 handling the prepaid service, the prepaid server 34 monitors the connection of the wireless device 12 in the voice network 36, and sends a billing or time record of the connection at a set interval during the connection. For example, the interval could be set to send the connection data every one minute.

This embodiment is particularly useful when, in a voice network 36, there is a long connection of voice or data transmission, where it is difficult or-impossible to determine a proper prepaid amount at the beginning of the connection. In current data transmission and voice network systems, if the server handling the connection to the wireless device 12 fails before a proper connection hang-up or disconnect is received, the billing data for the call or data transfer is lost. This results in a significant amount of connection time being lost and not billed to the user. The present embodiment avoids this problem by monitoring the connection at a preset interval during the connection and making a record of the connection at every occurrence of the interval.

The prepaid server 34 (or any appropriate system platform which is not handling the actual connection) monitors and stores the connection or data transfer information during the connection at the set interval and continually updates the connection records at each occurrence of the preset interval. Therefore, at any one given time, if the connection server or system fails before the connection is properly terminated then only one interval of billing time will be lost. For example, if the connection is monitored at one minute intervals and the connection is lost at 25 minutes and 52 seconds into the connection, the system will have record of at least 25 minutes of connection time, which can be properly billed, whereas in the prior art the entire connection time is lost and remains un-billed.

The interval to be used can be set at any time or duration depending on the system capabilities and billing requirements of the system operator. For example, the connection can be monitored at intervals of 10 seconds, however, this creates a significant amount of data to be collected and stored during a connection and can create a significant burden on some systems (depending on the system capacity). This is to be balanced with the billing requirements that are desired. For example, if the billing requirements are not as critical (i.e. the time used is not as costly), then an interval of one minute, or longer, may be used.

In a preferred embodiment of this aspect of the invention, a code “tag” is added to the Extensible Markup Language (XML) that is used to allow the communication of the wireless device 12 to the data network 40 or voice network 36. (Although it is noted that the present invention is not limited to the use of XML and can be used with any commonly known or used wireless markup language to define the use of the data received by the wireless device 12.) The “tag” or added code triggers the sending of the billing records of a call or connection to a URL, prepaid server 34, or any other location where the information is needed for billing, at set intervals to allow proper billing if the connection is lost prior to its proper disconnect.

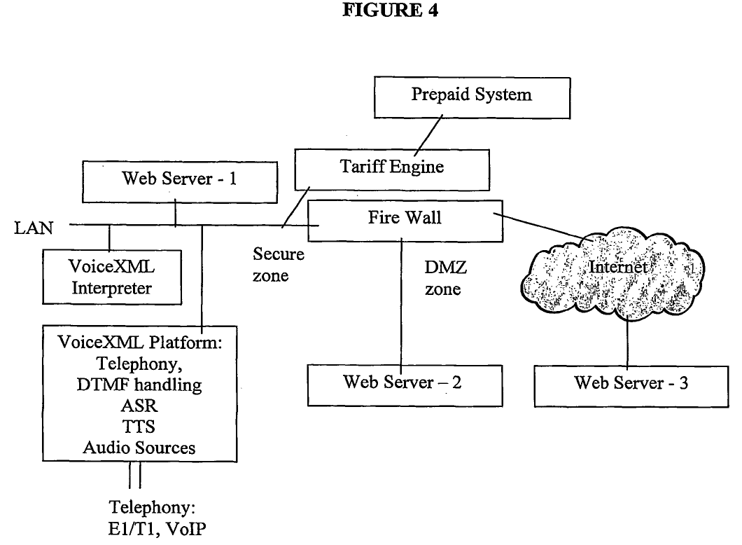

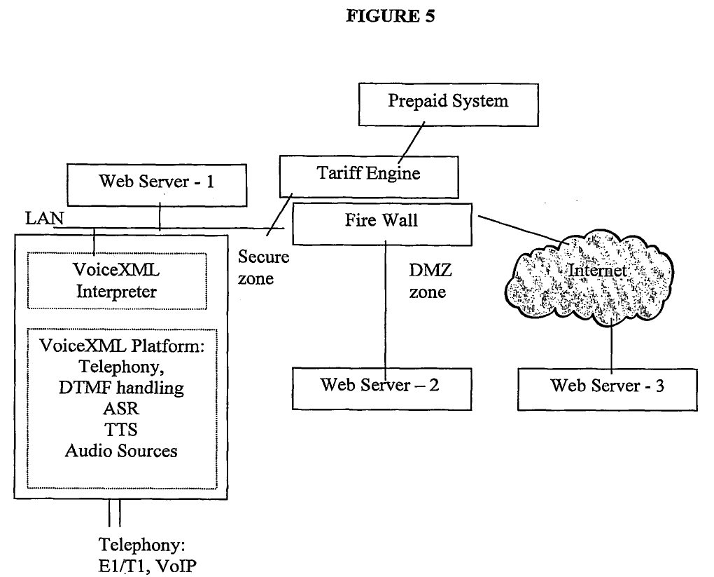

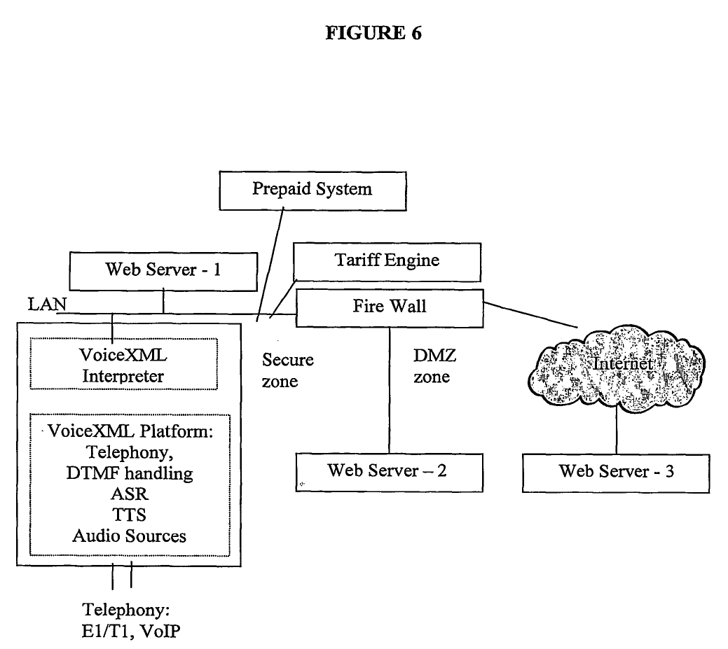

The use of the present invention will now be discussed with regard to exemplary embodiments of a Voice XML system as shown in FIGS. 4, 5 and 6. As shown in these Figures a Voice XML interpreter obtains Voice XML pages from any one of web server 1, web server 2, or web server 3. The Voice XML document which is obtained contains a script that is to be interpreted by the Voice XML interpreter which results in controlling the Voice XML platform. The Voice XML interpreter is connected to the telephony (or communication) subsystem that performs speech recognition, play prompt, or any other command required by the Voice XML interpreter. This results in a user interface session for a telephone, or communication subsystem. It is noted that the Voice XML platform and the Voice XML interpreter can be a part of the same unit as shown in FIGS. 5 and 6. The firewall is used in the system for security and essentially creates three zones within the system. There is a secured zone, protected by the firewall, a “demilitarized” (DMZ) or neutral zone, partially protected by the firewall, and the internet. It is noted that the DMZ, or neutral zone, is generally located between a private network (behind a firewall) and the internet to allow users of the internet to access one or at least some of a web provider's servers, while keeping some of the private servers off-limits behind a firewall. The web server from which the information, or web page, is to be obtained (i.e. web servers 1, 2 or 3) can be located in anyone of the three zones, as shown in FIGS. 4-6. When presenting information services, either the Voice XML interpreter or Voice XML platform can access a web server (1-3), file server, or any other source of data to get the requested or needed data.

In the present invention, the Voice XML platform (or equivalent platform) will, according to its configuration, be able to determine, or would know, which operations or data requests require billing and those that would not. The configuration can also indicate that a Tariff engine should be “consulted” for every operation and the returned answer from the prepaid system will determine whether to, and how much to bill. Essentially, when the Tariff engine is “consulted” the system sends a query to a pre-determined address according to a pre-set of rules and receives instructions on how to proceed. This can be alternatively referred to as a “manual” mode as the system does not automatically calculate the cost, but waits for instruction. For each operation which requires billing the system will access the prepaid system (which can be configured and operate as the prepaid server 34 shown in FIG. 2 and previously discussed) via the Tariff engine, and will request a certain amount of time to give the requested service. It is determined whether or not such time is available, and then if the time is available the operation proceeds. When the duration of the of the requested amount of time is near its end (about to elapse) the Voice XML platform will ask for an additional amount of time, which will be provided if it is available. This operation will be continued until the user elects to the end the service or the balance in the prepaid system becomes zero. This ensures that a negative balance is not accumulated, which can be a problem with existing billing systems. Additionally, because the system uses amounts or “chunks” of time from the prepaid system, at the end of the service any unused amount of time is returned to the prepaid system. The billing/refund operation of this aspect of the present invention can operate similar to that previously discussed.

Additionally, in some cases the “amount” or “chunk” received from the prepaid system can be an amount of data. This can be used when the Voice XML is extracting data from some source (e.g. some web server containing text or audio file) that determines the charge based on the amount of data (bytes) and not the time to present or transmit it. In this case, the mechanism and/or system used can be as explained earlier but the amount measured and exchanged will be bytes or service data and not tokens or money. It should be further noted that in some cases the two unused amounts (i.e. data and time) can be returned to the prepaid system and the system will measure the minimum of the two options.

Further, rather than request a chunk or amount and return the “left over” to the system, the system can “reserve” an amount of service. In return for the reservation request the system will receive (and reserve) the time/data to grant the service. When the reserved amount is complete or used up the system will request the prepaid system to “charge” the amount and reserve the next chunk. At the last chunk, which will usually be smaller than the allowed chunk, the system will request to charge the exact amount of service. For example, if the system was granted 60 seconds (under reserve) it will charge 45 seconds. The benefit of this method of system operation (as opposed to charge and credit at the end) is that if the system fails, the end user is never overcharged.

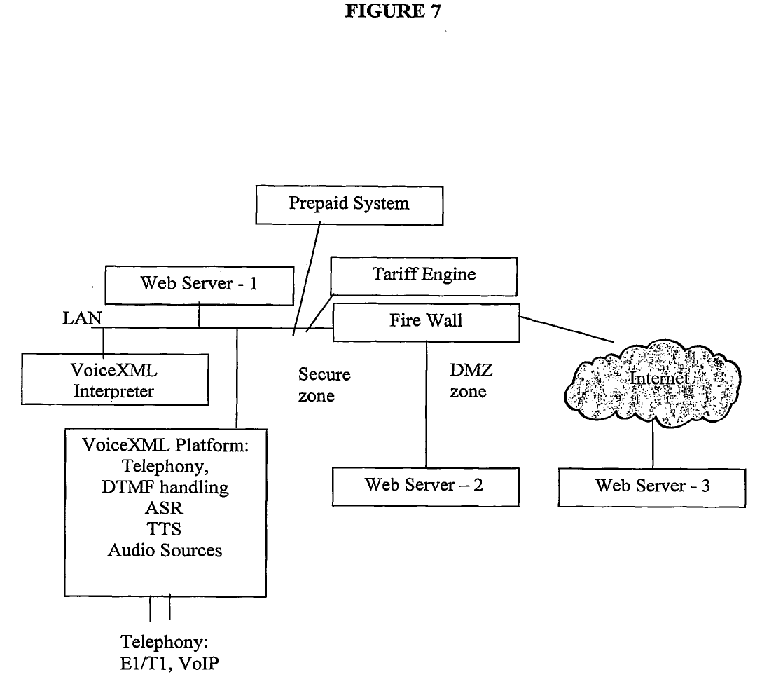

Further, the Voice XML interpreter shown in FIGS. 4-7 can be used to control the length of the operation or session in conjunction with the prepaid system. In FIGS. 4 and 5, the prepaid functionality (the VoiceXML interpreter or the VoiceXML platform) refers to the Tariff engine and the prepaid system as one unit. However, in FIGS. 6 & 7 the requester first accesses the Tariff engine to convert the service related feature (time/data) to a money amount and then connects to the prepaid system to actually charge/credit/reserve (depending on the mode of operation) this amount.

To perform the above function a Voice XML tag which commands the Voice XML interpreter or platform to send a charging record, or check the system for sufficient finds (or time), can be added to any number of existing or required Voice XML tags. For example, the additional tag required for the present invention can be added to the transfer, prompt, and/or call initiation request tags already existing in the Voice XML system. It is noted that the Voice XML tag for the present invention is not limited to these locations, but can also be placed in any other appropriate location. As an example, when a user requests a service from a web server, initially the web server cannot “talk” or communicate with the prepaid system, so within the Voice XML “prompt” tag a tag or parameter is added to cause the web server to get “permission” from the prepaid server, to transmit data for a set time period. When the Voice XML platform or interpreter receives the command to proceed it will proceed with the service, but at every pre-set time period it will inform the prepaid system of the service it is giving and will request permission to continue. It is noted that in the preferred embodiment, the system will request permission from the prepaid system to proceed before service actually begins. Further, in yet another embodiment of this aspect of the invention, a Voice XML tag can be inserted which contains a URL to which data regarding the service can be sent at every time period or interval in the data transfer.

It is to be noted that the present invention is not limited to the use of Voice XML, but can be used with any scripting language that executes at the system platform or interpreter.

Further, in addition to being used in voice network application, the above embodiment can also be used in data transfer applications in a similar fashion. However, in the preferred embodiment, if the data transfer is incomplete and results in useless information to the wireless device 12, the billing system (i.e. prepaid server 34) is triggered to not bill for the connection time, as the data transfer was unsuccessful.

Further, it is contemplated that this embodiment of the present invention can be coupled with any or all of the embodiments previously discussed. For example, before a data transfer occurs a cost for the transfer is calculated or estimated, and the prepaid server 34 determines whether or not sufficient “tokens” exist in the appropriate account before the data transfer is allowed to continue. When the prepaid server 34 determines that the transfer can continue, the above embodiment can be incorporated to monitor the actual connection time, thus allowing the prepaid server 34 to determine whether or not the actual connection time exceeds the calculated or estimated amount and interrupts the transfer or connection when such an event occurs.

It should be finally noted that the above aspects of the present invention are not limited to prepaid billing systems, as previously described, but can be used in any IVR system where there is the possibility for a voice/data connection record to be lost when a failure occurs in the server or system handling the connection, nor is the present invention limited to wireless communication systems.

It will be appreciated that the above descriptions are intended only to serve as examples, and that many other embodiments are possible within the spirit and the scope of the present invention.

What is claimed is:

1. A method for providing prepaid data transfer service, the method comprising:
(a) receiving a request for data;
(b) calculating a cost of providing the data; and
(c) determining whether a sufficient amount to cover said cost is available in an account.

2. The method of claim 1, further comprising:
(d) initiating the data transfer service if said sufficient amount is available.

3. The method of claim 2, further comprising:
(e) blocking the data transfer service if said sufficient amount is not available.

4. The method of claim 3, further comprising:
(f) sending a message or said data to a wireless device.

5. The method of claim 4, wherein said message comprises a recharge URL.

6. The method of claim 1, wherein (b) is performed by calculating said cost according to at least one of an amount of data required for the data transfer service, a type of data and an identity of a data source for providing the data, the date and time of the data transfer, and the subscriber's class of service.

7. The method of claim 6, wherein (b) further comprises:
(i) calculating a cost of the data transfer service in an arbitrary unit; and
(ii) converting said arbitrary unit into a charge to said prepaid account of the subscriber.

8. The method of claim 7, wherein (ii) is performed according to at least one of the date and time of the data transfer, and a class of service for the subscriber.

9. The method of claim 8, wherein said class of service is defined according to at least one rule for each subscriber.

10. The method of claim 8, wherein (i) is performed according to at least one of an amount of data required for the data transfer service, a type of data and an identity of a data source for providing the data.

11. The method of claim 1, wherein (b) comprises:
(i) calculating a cost of the data transfer service in an arbitrary unit; and
(ii) converting said arbitrary unit into a charge to said prepaid account of the subscriber.

12. The method of claim 11, wherein said arbitrary unit is set with an expiration time.

13. The method of claim 12, wherein after said expiration time said arbitrary units are converted into a second charge to said prepaid account, wherein said second charge has a different value than said charge.

14. The method of claim 12, wherein said expiration time is a function of at least one of the date and time.

15. The method of claim 1, wherein a sufficient amount is determined as an amount in said prepaid account above a minimum negative balance threshold.

16. The method of claim 1, further comprising:
(d) calculating an actual cost for performing the data transfer service; and
(e) obtaining payment from said prepaid account of the subscriber.

17. The method of claim 16, wherein (d) is performed only after the data transfer service is complete.

18. The method of claim 16, wherein (d) is performed as the data transfer service is being performed.

19. The method of claim 1, further comprising:
(d) transmitting said data; and
(e) monitoring an actual cost of transmitting said data.

20. The method of claim 19, wherein said monitoring occurs at a set interval during transmitting of said data.

21. The method of claim 19, further comprising:
(f) blocking said the data transfer if said actual cost exceeds said calculated cost.

22. The method of claim 1, further comprising:
(d) denying a service user, having a class of service, from receiving said data if said sufficient amount is not available, wherein said denial is based on at least said user's class of service.

23. A method of providing a prepaid data transfer service, the method comprising:
(a) receiving a request for data;
(b) estimating a cost of providing said data;
(c) determining whether a sufficient amount to cover said estimated cost is available in an account;
(d) initiating the data transfer service if said sufficient amount is available; and
(e) monitoring an actual cost of the data transfer service during the data transfer service.

24. The method of claim 23, wherein said monitoring occurs at a set interval during said data transfer service.

25. The method of claim 23, further comprising:
(f) blocking the data transfer service is said actual cost exceeds the estimated cost.

26. A system for providing a prepaid data transfer service to a subscriber of data from a data source, comprising:
(a) a communication device for operation by the subscriber;
(b) a data network for connecting said communication device to the data source; and
(c) a prepaid system for being connected to said data network and said communication device, for determining a cost for transferring the data to said communication device and for storing a subscriber account, said subscriber account having a prepaid amount, such that said prepaid system determines whether to permit the data transfer service according to a comparison of said cost and said prepaid amount in said subscriber account.

27. The system of claim 26, wherein said prepaid system comprises:
(i) a data monitor connected to said data network for monitoring data traffic over said data network, including a request from said communication device for the data transfer service, and for calculating said cost; and
(ii) a prepaid server for managing said subscriber account and for determining whether to authorize the data transfer service according to said comparison between said cost and said prepaid amount.

28. The system of claim 27, wherein said data monitor calculates said cost in arbitrary units, and said prepaid server converts said arbitrary units into an actual amount for debiting said subscriber account.

29. The system of claim 28, wherein said arbitrary units are set with an expiration time.

30. The system of claim 29, wherein after said expiration time said prepaid server converts said arbitrary units into a second actual amount for debiting said subscriber account, wherein said second actual amount is different than said actual amount.

31. The system of claim 29, wherein said expiration time is a function of at least one of the date and time.

32. The system of claim 26, further comprising:
(d) a voice network in communication with said prepaid server, such that said prepaid server also determines whether to authorize a voice service according to a comparison between a cost of said voice service and said prepaid amount.

33. The system of claim 26, wherein said prepaid system monitors a connection between said communication device and said data source at a preset interval and determines an actual cost of said connection during said connection at each occurrence of said interval, such that said prepaid system determines whether to permit the data transfer service according to a comparison of said actual cost and said prepaid amount in said subscriber account.

34. The system of claim 32, wherein said prepaid system monitors a connection between said communication device and at least a second wireless device connected to said voice network at a preset interval and determines an actual cost of said connection during said connection at each occurrence of said interval, such that said prepaid system determines whether to continue said connection between said communication device and said second communication device according to a comparison of said actual cost and said prepaid amount in said subscriber account.

35. The system of claim 26, wherein said communication device is a wireless communication device.

36. The system of claim 26, wherein said communication device is a wireline communication device.

37. A system for providing a prepaid data transfer service to a subscriber of data from a data source, comprising:
a prepaid system, wherein said prepaid system determines a cost for transferring data and stores a subscriber account, said subscriber account having a prepaid amount, such that said prepaid system determines whether to permit the data transfer service according to a comparison of said cost and said prepaid amount in said subscriber account.

38. The system of claim 37, further comprising a communication device for operation by said subscriber.

39. The system of claim 37, flier comprising a data network for connecting a communicating device to the data source.
